(19) United States
(12) Patent Application Publication
(10) Pub. No.: US 2007/0011742 A1
(43) Pub. Date: Jan. 11, 2007

(54) Communication information monitoring apparatus

(76) Inventors: Kojiro Nakayama, Yokohama (JP); Masayuki Sakata, Matsudo (JP); Takeshi Ishizaki, Yokohama (JP); Kenya Nishiki, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/274,411

(22) Filed: Nov. 16, 2005

(30) Foreign Application Priority Data
Jun. 27, 2005 (JP) 2005-186694

(51) Int. Cl. G06F 12/14

(52) U.S. Cl. 726/22

(57) ABSTRACT

A check rule for assuring system security is generated. A communication information monitoring apparatus includes a pseudo-client, a monitoring unit, and a unification unit. The pseudo-client transmits a request message containing a trace value as a parameter to a web application and analyzes a response message returned from the web application. The monitoring unit monitors whether the trace value transmitted by the pseudo-client is used in various positions in the system. The unification unit generates a check rule according to the processing result of the pseudo-client and the monitoring unit and a check policy registered in advance. The check policy contains the parameter use purpose and the process for the check processing.

### INCORPORATION BY REFERENCE

The present application claims priority from Japanese application P2005-186694 filed on Jun. 27, 2005, the content of which is hereby incorporated by reference into this application.

### BACKGROUND OF THE INVENTION

The present invention relates to a communication information monitoring apparatus which can be preferably applied to an information security, for example, and in particular, to a technique for protecting a system from an attack in a system providing a service via a network.

With the development of the network technique such as the Internet and intranet, a plenty of systems currently provide serves to clients via a network. As a system providing a service via such a network, for example, the Web application is used.

When using the web application, a client transmits a request message to the Web application. The Web application returns a response message for it. The request message and the response message are transmitted and received by using the HTTP (HyperText Transfer Protocol). Moreover, the response message contains a Web page described by using the HTML (HyperText Markup Language).

The request message transmitted by a client may contain various parameters. These parameters are contained, for example, in POST payload, URL query, and cookie. These parameters are used in various processes in the web application. For example, they are used as a part of the SQL (Structured Query Language) statement for accessing the database or contained in a web page to be transmitted to a client.

Thus, the parameter transmitted from a client affects the operation of the web application. Accordingly, if an unauthorized command or script is described in the parameter, the web application may perform an operation out of predetermined operations. For this, the parameter contained in the request message is often used for attacking the web application. As a technique for attacking the web application using a parameter, for example, there are the cross site scripting (hereinafter, referred to as XSS) attack and the SQL injection.

When the web application includes the received parameter directly in the response web page, there may exist vulnerability against the XSS attack. When the XSS attack is successful, the unauthorized script described in the parameter is included in the web page returned by the web application and executed on the client. This may cause a significant problem such as wiretap and alteration of the cookie.

When the web application uses the received parameter as a part of the SQL statement for accessing the database, there may exist vulnerability against the SQL injection. When the SQL injection is successful, the character string described in the parameter issues an SQL statement having a meaning other than the predetermined ones. This may cause a significant problem such as spoofing and leak of important data.

In order to prevent attack to the web application using the parameter, it is effective to check whether the parameter transmitted from the client includes an unauthorized character string. The system for checking the parameter included in the request message is, for example, called web application firewall (hereinafter, referred to as WAF) and used already in practice.

Hereinafter, explanation will be given on an example of parameter check with reference to FIG. 13. In the example of FIG. 13, a security filter 103 executes a parameter check. A client 101 is connected to the security filter 103 via a network 102. The security filter 103 may be connected to a web application 104 via the network or may operate on the same computer.

The client transmits a request message to the web application 104. The security filter 103 cuts off the request message transmitted from the client and performs a parameter check. The check is executed according to a predetermined check rule 105.

There are various methods for checking a parameter. For example, a character string which may cause a security problem may be set in advance as an inhibited character string in the check rule 105. In this case, the security filter cuts off the request from the client and checks whether the parameter includes the inhibited character string.

That is, when the inhibited character string is included, the request is transferred directly to the web application. When the inhibited character string is included, the request is rejected and an error is returned to the client 101. By performing such a parameter check, it is possible to protect the system from the attack to the web application.

Here, in order to effectively function the security filter 103, it is necessary to set an appropriate check rule 105. However, the setting of the check rule 105 is often a complicated work. That is, in order to specify an inhibited character string, it is necessary to have detailed knowledge of each attack method. For this, setting of the check rule requires knowledge of sophisticated security.

Moreover, the character string used in the XSS attack is different from the character string used in the SQL injection. Accordingly, for the parameter which may be used in the XSS attack, a check rule for the XSS attack should be set while for the parameter which may be used in the SQL injection, a check rule for the SQL injection should be set.

Consequently, in order to set an appropriate check rule for protecting the system from the attack to the web application, it is necessary to have detailed knowledge of the web application. Thus, the setting of the check-rule is a sophisticated work requiring both of the knowledge of security and knowledge of the web application.

As a technique associated with setting of such a check rule, there is known a technique for analyzing a response message, for example, so as to limit the range which the parameter may be in for example, U.S. Pat. No. 6,311,278.

Moreover, as a technique for detecting vulnerability of the XSS attack, there is a technique for inserting a trace value into the request message and analyzing the response message obtained as a result, thereby checking whether the web application has vulnerability against the XSS attack (for example, see JP-A-2004-164617).

That is, the technique for setting the check rule and the technique for checking whether vulnerability against the XSS attack is present are known from U.S. Pat. No. 6,311,278 and JP-A-2004-164617.

However, the technique disclosed in U.S. Pat. No. 6,311,278 has a problem that for a parameter having a high degree of freedom of description, it is possible to limit the value and sufficient check may not be executed. Moreover, the technique disclosed in JP-A-2004-164617 has a problem that only the analysis of the response message is performed and it is impossible to detect an attach executing an unauthorized command in the web application such as the SQL injection.

### SUMMARY OF THE INVENTION

The present invention is for solving the aforementioned problems. The object of the present invention is to easily create an appropriate check rule without having a detailed knowledge of the security and web application.

In order to achieve the aforementioned object, the communication information monitoring apparatus according to the present invention includes a pseudo-client, a monitoring unit, and a unification unit.

That is, the present invention traces a parameter by the pseudo-client and the monitoring unit so as to specify the position where the parameter is used. The pseudo-client sets a trace value as a parameter value and transmits a request message for the system providing a service to a client via a network. That is, the pseudo-client 501 transmits a request message including a trace value as a parameter to the web application and analyzes the response message returned from the web application. The monitoring unit monitors whether the trace value is used as various positions in the system. Thus, it is possible to identify the positions where the parameter in the request message is used.

Furthermore, the unification unit generates an appropriate check rule according to the trace result by the pseudo-client and the monitoring unit and according to the predetermined check policy. The check policy has an appropriate check rule set to be used in the positions where the parameter is used. That is, in the check policy 510, correspondence between the parameter use purpose and the check process is registered. Accordingly, by correlating the check policy to the trace result where the parameter use position is described, it is possible to easily generate an appropriate check rule.

By using the aforementioned invention, even a person having no sophisticated security knowledge or detailed system information can easily create a check rule. Moreover, by applying the present invention, it is expected to reduce the number of system configuration steps and the number of setting mistakes.

Other objects, features and advantages of the invention will become apparent from the following description of the embodiments of the invention taken in conjunction with the accompanying drawings.

### BRIEF DESCRIPTION OF THE DRAWINGS

FIG. 1 a block diagram showing a system according to an embodiment of the present invention.

FIG. 2 is block diagram of hardware of a computer for carrying out the present invention.

FIG. 3 is a block diagram showing an internal configuration of the application for explaining FIG. 2.

FIG. 4 is a block diagram showing an internal configuration of communication information monitoring device to which the present invention is applied.

FIG. 5 is a flowchart of a check rule generation processing according to the present invention.

FIG. 6 shows an example of response message for explaining FIG. 5.

FIG. 7 shows an example of an output screen view generated by a pseudo-client for explaining FIG. 6.

FIG. 8 shows an example of a request message generated by the pseudo-client for explaining FIG. 7.

FIG. 9 shows an example of a trace result generated by the pseudo-client for explaining FIG. 8.

FIG. 10 shows an example of a check policy for explaining FIG. 9.

FIG. 11 shows an example of a parameter trace result for explaining FIG. 10.

FIG. 12 shows an example of a check rule generated by the check rule generation device for explaining FIG. 11.

FIG. 13 shows a configuration of a system performing a parameter check.

### DESCRIPTION OF THE EMBODIMENTS

Description will now be directed to preferred embodiments of the present invention with reference to the attached drawings.

Hereinafter, explanation will be given on an embodiment of the web application as an example of a system providing a service to a client. However, the present invention is not to be limited to the web application. Moreover, in the example given below, a parameter check is performed by a security filter existing outside the web application. However, the present invention can also be applied to a parameter check performed inside the web application.

[Outline of the Entire System]

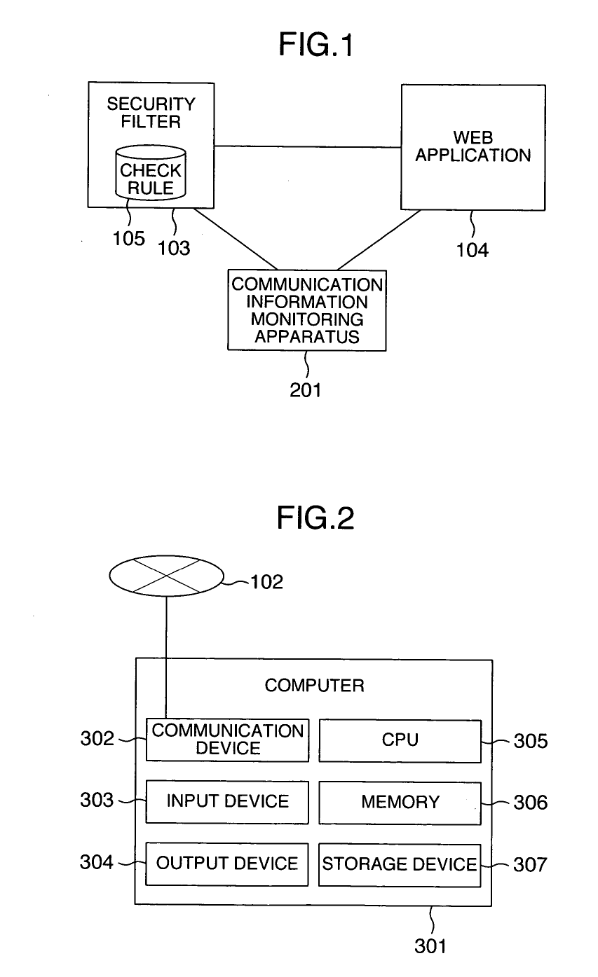

FIG. 1 shows the entire configuration of the present embodiment. The web application 104 provides a service to a client (not depicted). The security filter 103 checks a parameter contained in a request message so as to prevent attack to the web application 104. The parameter check is executed according to a check rule 105. The check rule is generated by a communication information monitoring device 201 as will be detailed below.

[Hardware Configuration of Computer]

The web application 104, the security filter 103, the communication information monitoring device 201 can be realized by a general computer 301 as shown in FIG. 2. The computer 301 includes a CPU 305, a memory 306, a storage device 307 such as a hard disk, an input device 303 such as a keyboard and a mouse, an output device 304 such as a display, and a communication device 302 for connection to a network.

The computer 301 is connected to a network 102 such as the Internet via the communication device 105. In the computer 301, the CPU executes a predetermined program called by the memory 306, thereby realizing the respective functions. The web application 104, the security filter 103, and the communication information monitoring device 201 may be executed in different computers or in a single computer.

[Internal Configuration of Web Application]

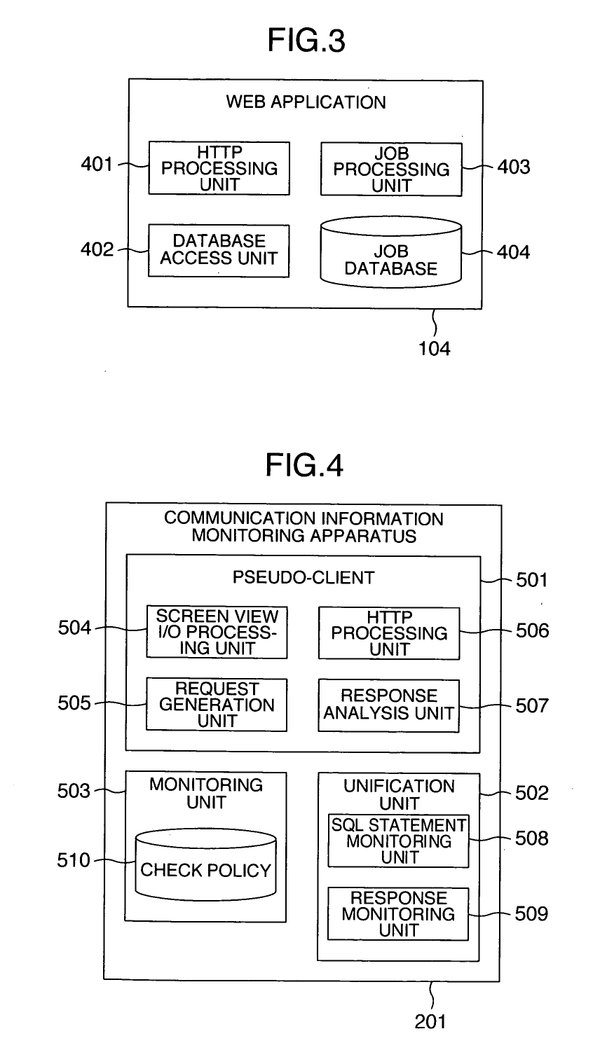

FIG. 3 shows an example of internal configuration of the web application 104. When the web application 104 receives a request message from the client, the web application 104 executes various jobs according to the request message and returns a response message to the client. The request message transmitted from the client is received by an HTTP processing unit 401.

Processes executed by a job processing unit 403 greatly differ depending on the web application. For example, in the web application of the online shopping, processes such as a commodity search and a commodity purchase are performed. A job database 404 stores various data required for executing jobs. For example, commodity data is stored in the job database 404. The job processing unit 403 generates an SQL statement for accessing the job database 404 by using a parameter contained in the request message.

A database access unit 402 accesses the job database 404 according to the SQL statement generated by the job processing unit 403 and performs processes such as search and update. Moreover, the job processing unit 403 generates a web page to be returned to a client, by using an access result to the job database 4094 and a parameter contained in the request message. The generated web page is returned to the client by the HTTP processing unit 401.

[Internal Configuration of Communication Information Monitoring Device]

FIG. 4 shows an example of internal configuration of the communication information monitoring device 201. The communication information monitoring device 201 includes a pseudo-client 501, a monitoring unit 502, and a unification unit 503.

[Pseudo-Client]

As will be detailed below, the pseudo-client 501 transmits a request message containing a trace value as a parameter to the web application and analyzes a response message returned from the web application. The pseudo-client 501 includes a screen view I/O processing unit 504, a request generation unit 505, a response analysis unit 507, and an HTTP processing unit 506. The HTTP processing unit 506 transmits a request message and receives a response message.

The response analysis unit 507 analyzes a response message returned from the web application and generates a parameter list which will be explained below. The screen view I/O processing unit 504 displays on the screen the analysis result obtained by the response analysis unit 507 and receives a user input. The request generation unit generates a request message containing a trace value as a parameter.

[Monitoring Unit]

The monitoring unit 502 monitors whether the trace value transmitted by the pseudo-client 501 is used in various places in the system. In this embodiment, as an example of the monitoring process, explanation will be given on the SQL statement monitoring and the response message monitoring. If necessary, monitoring can be performed in other places.

An SQL statement monitoring unit 508 monitors the SQL statement used when the job database 404 is accessed. The SQL monitoring is realized, for example, by linking with the database access unit 402 or monitoring the communication between database access unit 402 and the job database 404. Moreover, the SQL statement may be monitored by a method other than this.

A response monitoring unit 509 monitors response data returned from the web application 104. The monitoring of the response message can be realized, for example, by linking with the HTTP processing unit 506 of the pseudo-client 501 or monitoring the communication between the web application 104 and the pseudo-client 501. Moreover, the response data may be monitored by a method other than this.

[Unification Unit]

The unification unit 503 generates a check rule 105 according to the processing result obtained by the pseudo-client 501 and the monitoring unit 502 and the check policy 510 registered in advance. In the check policy, the parameter use purpose is registered while being correlated with the check processing.

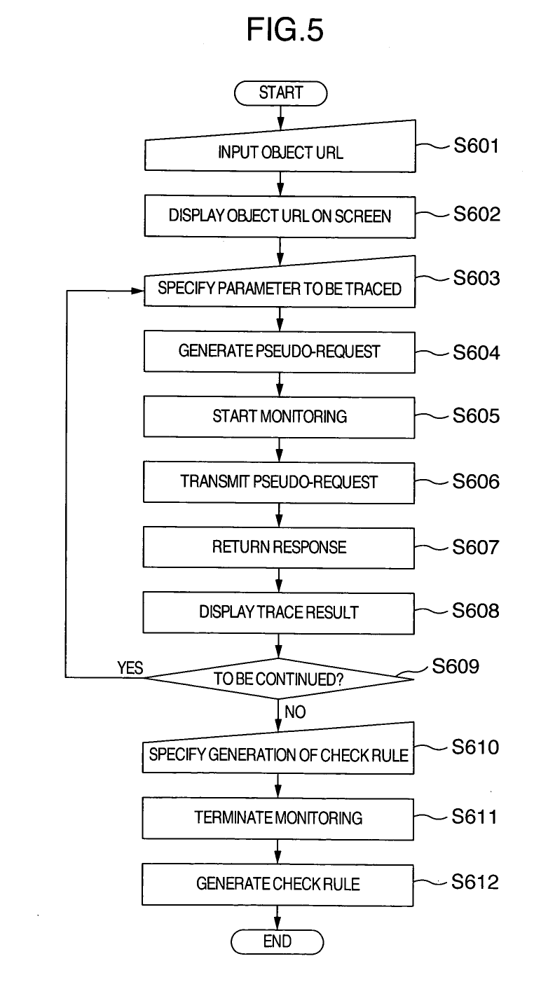

Hereinafter, referring to the flowchart of FIG. 5, the check rule generation processing will be detailed. The check rule generation processing is executed, for example, when a user inputs an instruction to the communication information monitoring device 201 by using the GUI (Graphical User Interface).

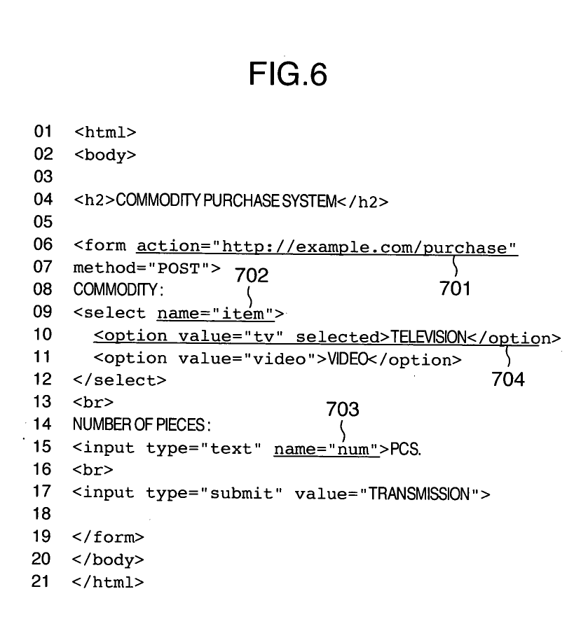

When an instruction is inputted, firstly, in Step S601, the user inputs URL of the web application to the pseudo-client 501. Next, in Step S602, the pseudo-client 501 transmits a request message to the web application 104 in the same way as the ordinary browser and receives a response message. Here, an example of the response message returned from the web application is shown in FIG. 6. A specific example will be explained.

The response message shown in FIG. 6 is described by using the HTML. It should be noted that in FIG. 6, each line starts with a line number but the actual response message does not contain any line number.

In the message shown in FIG. 6, Line 01 to Line 21 are enclosed by html tags. This indicates that the content enclosed by the html tags are data described by HTML. Moreover, Line 02 to Line 20 are enclosed by body tags. This indicates that the contents enclosed by the body tags are the main text of the HTML. Furthermore, in Line 04, a character string “commodity purchase system” is enclosed by h2 tags. This indicates that the characters “commodity purchase system” represent a headline.

Moreover, Line 06 to Line 18 are enclosed by form tags. This indicates that the contents enclosed by the form tags are one form. The action attribute (Line 06) of the form tag represents the URL of the transmission destination of the input content. Moreover, the method attribute (Line 07) of the form tag represents the HTTP method used when transmitting the input content.

Furthermore, Line 09 to Line 12 are enclosed by select tags. This indicates that the content enclosed by the select tags is one select box. The select box is one of the parts below the form and the value selected here is transmitted as one of the parameters to the web application. When the parameter is transmitted, the name attribute (Line 09) of the select tag is used as a name of the parameter.

The option tags in Line 10 and Line 11 respectively represent selection candidates of the select box. When the content enclosed by the option tags is selected, the value of the value attribute of the option tag is transmitted as a parameter value to the web application.

For example, when “television” is selected, a parameter having “item” as a name and “tv” as a value is transmitted to the web application. Moreover, when “video” is selected, a parameter having “item” as a name and “video” as a value is transmitted to the web application. It should be noted that the select tag in Line 10 has the selected attribute. This indicates that the option tag in Line 10 has been selected in advance.

Furthermore, <br> in Line 13 and Line 16 represents a new paragraph. Moreover, the input tags in Line 15 and Line 17 represents one of the parts of the input form.

Here, the input tag having a text as the type attribute like in Line 15 represents a text input field. The name attribute of the input tag is used as a parameter name when transmitting the parameter. In Line 15, the name of the name attribute is “bikou”. Accordingly, the value inputted in the text input field is transmitted as a value of the parameter whose name is “bikou” to the web application.

Moreover, like in Line 17, the input tag having a submit as the type attribute represents an execution button. Here, when the execution button is pressed, the content of the input form is transmitted as a parameter to the web application. Thus, a response message is received in response to the request message transmitted from the pseudo-client 501 to the web application 104.

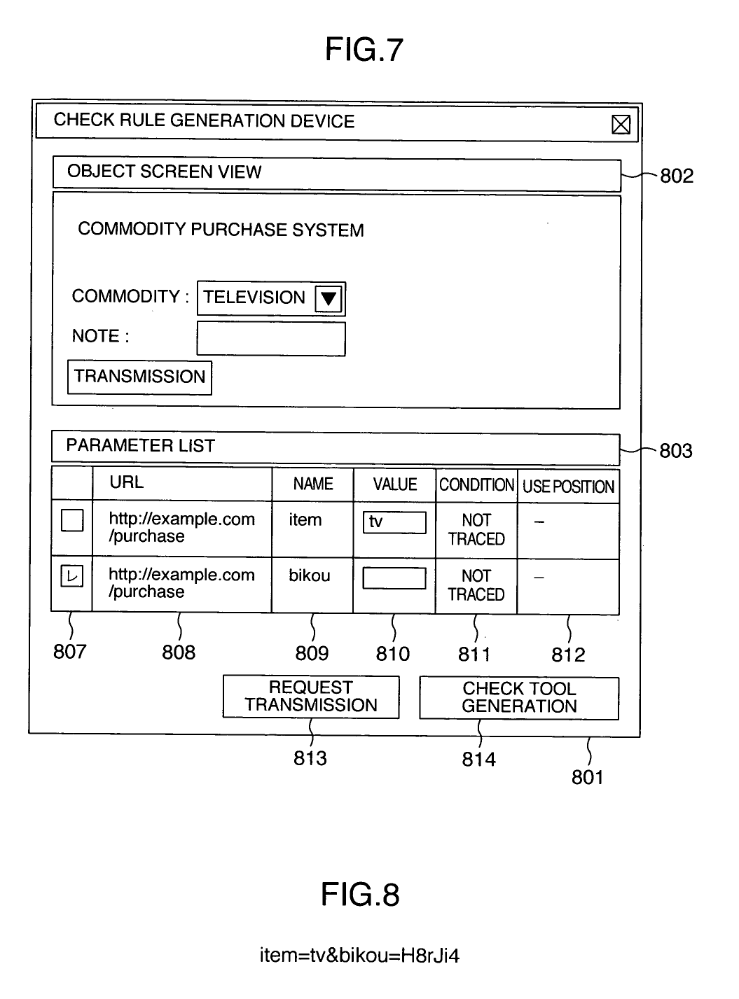

In Step S602 in FIG. 5, the response message received is analyzed by the response analysis unit 507 and displayed on the screen by the screen view I/O processing unit 504. An example 801 displayed in FIG. 7 is shown. The object screen 802 on the upper portion of the screen view displays the response message returned by the web application like an ordinary browser. The parameter list 803 at the lower portion of the screen view shows a list of parameters to be transmitted from the client by the next request by making judgment from the content of the HTML.

In the respective items of the parameter list 803, a check box 807, an URL 808, a name 809, a value 810, a condition 811, and a result 812 are displayed. The check box is used when a user specifies a parameter to be traced as will be explained below. The URL 808 is a column showing the URL of the parameter transmission destination. In the HTML shown in FIG. 6, the URL (http://example.com/purchase) is described in the action attribute 701 of the form tag.

The name 809 is a column showing the name of the parameter. In the HTML shown in FIG. 6, the name “item” is described in the name attribute 702 of the select tag and the name “bikou” is described in the name attribute 703 of the input tag.

The value 810 is a column showing the value of the parameter. In the HTML, when an initial value and a value selected in advance are specified, they are displayed here. In the HTML shown in FIG. 6, for the parameter having a name “item” (hereinafter, referred to as an “item” parameter), a value “tv” is selected in advance and accordingly, “tv” is displayed in the value 810. For the parameter having a name “bikou” (hereinafter, referred to as a “bikou” parameter), no initial value or no value selected in advance exists and accordingly, an empty text box is displayed.

The condition 811 is a column for displaying the trace condition of each parameter. However, in Step S602, no parameter trace is performed yet and the characters “not traced” are displayed for all the parameters. The use position 812 is a column where the trace result of each parameter is displayed. In Step S602, no parameter trace is performed yet and a short line “-” indicating that no result is obtained is displayed for all the parameters.

Returning to the flowchart FIG. 5, in Step S603, the user specifies the parameter to be traced. Here, the user selects a parameter to be traced among the parameters displayed in the parameter list 803 and puts a mark in the check box 807. As will be explained below, for the parameter having the mark in the check box 807, a trace value is set as the parameter value.

Moreover, for the parameter not to be traced, i.e., for the parameter having no mark in the check box 807, the column of the value 810 is edited so as to set an arbitrary character string for the parameter value. Furthermore, when specification of the parameter is complete, the user presses the request transmission button 813.

When the request transmission button 813 is pressed in Step S604, the request generation unit 505 generates a pseudo-request message for tracing the parameter. FIG. 8 shows an example of the pseudo-request generated. In the example of FIG. 8, only the POST payload including the parameter is described among request messages.

Moreover, the request generation unit sets a trace value as a parameter value for the parameter having the mark in the check box 807. As the trace value, for example, a random character string can be used. When setting trace values for a plurality of parameters, different trace values are set for them. In the example of FIG. 8, for the “bikou” parameter, a random character string “H8rJi4” is set as the trace value.

Furthermore, in Step S605, the monitoring unit starts monitoring of the trace value. When the pseudo-request is transmitted, each of the monitoring units in the monitoring unit 502 starts monitoring of the system. That is, the SQL statement management unit 508 monitors the SQL statement transmitted to the job database and monitors the request message generated in Step S604. When the SQL statement issued includes a trace value, it is understood that the parameter to be traced is used in the SQL statement.

Moreover, the response management unit 509 monitors the response message returned from the web application to the client. When the response message contains a trace value, it is understood that the parameter to be traced is used for screen view output.

Furthermore, in Step S606, the HTTP processing unit 506 of the pseudo-client 501 transmits the pseudo-request generated by the request generation unit 505 to web application. Moreover, in Step S607, the web application 104 performs the same process as when a normal request is received. That is, the pseudo-request is received, a job process is performed, and a response is returned to the pseudo-client.

In Step S608, when the response message is returned from the web application, the pseudo-client displays the trace result to the user.

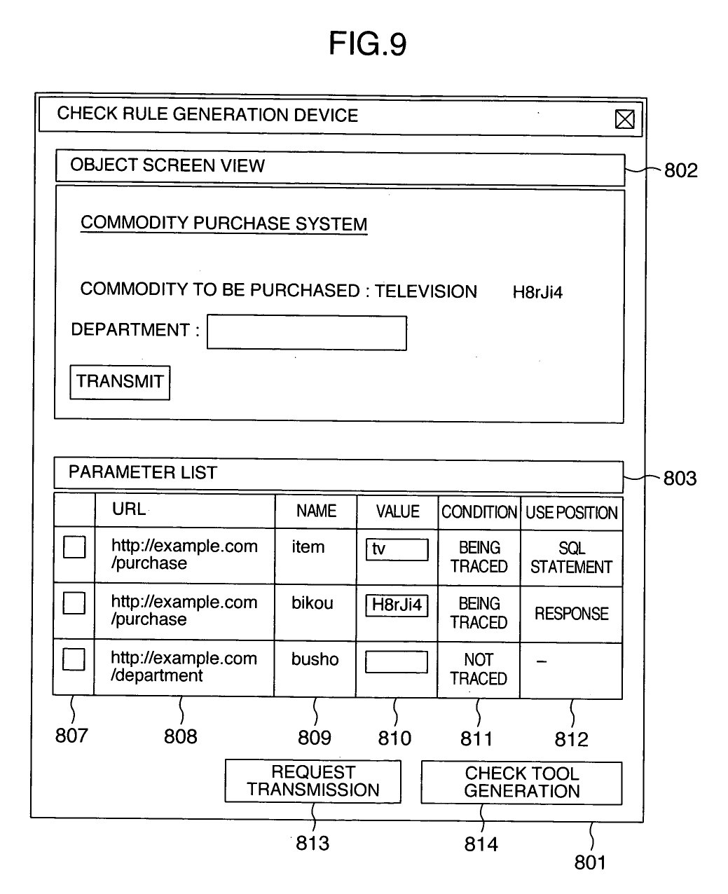

FIG. 9 shows an example of display of the trace result. The basic configuration of the screen view is identical to that of FIG. 7. The object screen view 802 displays the HTML returned in Step S607 by the same method as in the ordinary browser. The parameter list 803 contains the parameters displayed in Step S602 and a new parameter contained in the HTML returned in Step S607. Moreover, in the example of FIG. 9, a new parameter having a name “busho” is added. The transmission destination of this parameter is “http://example.com/department”.

Furthermore, the parameter list 803 displays the trace result monitored by the monitoring unit 502 for the parameters (the “item” parameter and the “bikou” parameter) displayed in Step S602. In the use position 812, the character string “SQL statement” is outputted when the trace value is detected by the SQL statement monitoring unit 508 and the character string “response” is outputted when the trace value is detected by the response monitoring unit 509. Thus, the user can know the position in the system where each parameter is used.

In Step S609, the user selects to continue the parameter trace processing or terminate the trace processing and generate a check rule. When the trace is to be terminated here, the user presses the check tool generation button 814 in Step S610. When the check tool generation button 814 is pressed, the monitoring unit 502 terminates monitoring in Step S611. After this, in Step S612, the unification unit 503 generates a check rule.

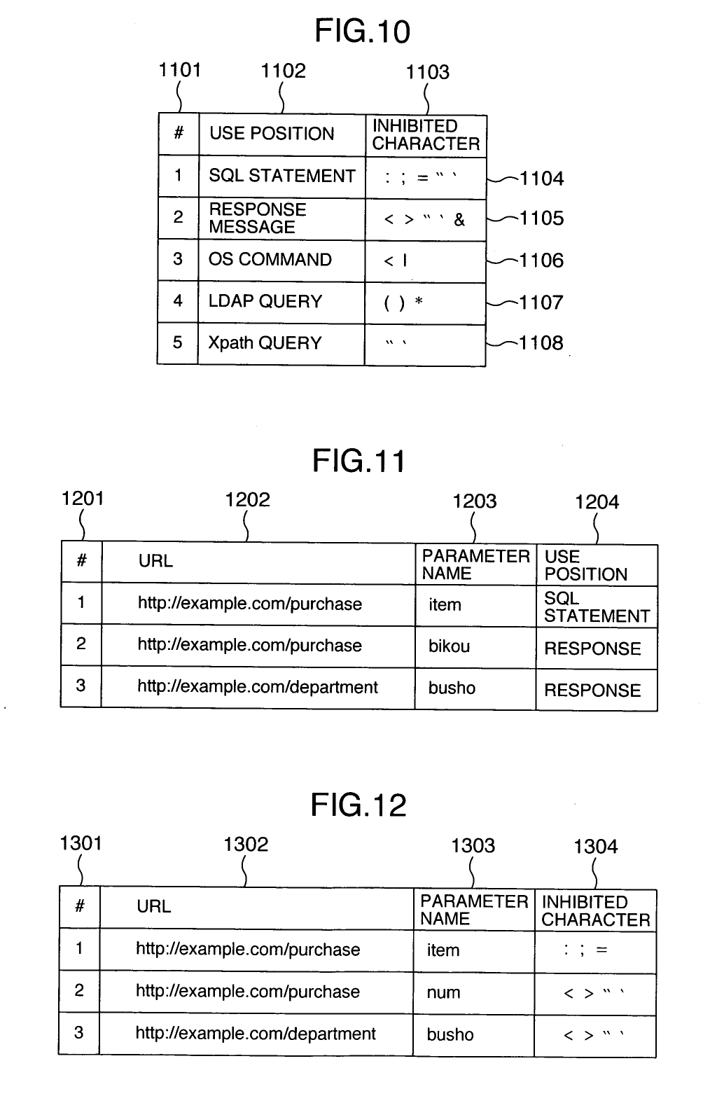

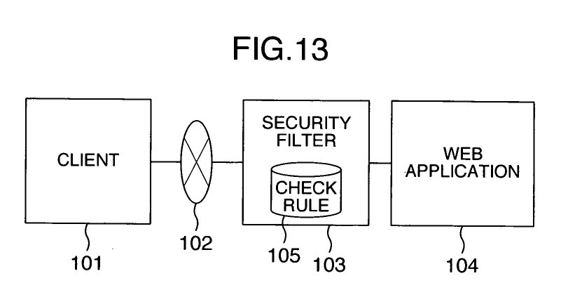

It should be noted that a check policy 510 indicating the check principle is set in advance for the unification unit 503. For example, information shown in FIG. 10 is set in the check policy. Each line of FIG. 10 represents one check policy. The first column 1101 indicates a line number added for explanation. The second column 1102 indicates the parameter use position. The parameter use position may be, for example, an SQL statement and a response message. The third column 1103 shows inhibited characters. When the parameter value contains a character specified here, the request is rejected and an error is returned to the client.

That is, Line 1 in FIG. 10 shows a check policy that when a parameter used in an SQL statement has a parameter value using one of the colon (:), a semi colon (;), an equal (=), a double quotation (“), and a single quotation ('), the request is rejected and an error is returned to the client.

Here, the characters such as the colon, the semi colon, the equal, the double quotation, and the single quotation have special meanings in the SQL. When these characters are used for malicious purpose, the SQL injection attack may occur. Consequently, by inhibiting these characters, it is possible to prevent the SQL injection.

Moreover, Line 1105 in FIG. 10 indicates a check policy that when the parameter used in the HTML of the response message has a parameter value using one of the symbols “<”, a double quotation ““”, a single quotation “'” and “&”, the request is rejected and an error is returned.

Here, the symbols “<”, “>”, a double quotation ““”, a single quotation “'”, and “&” are characters used when describing a script. When these characters are abused, there arises a possibility of the cross site scripting attack. So, by inhibiting use of these characters, it is possible to prevent the cross site scripting.

Furthermore, in the example of FIG. 10, various check policies are set: a check policy to prevent an OS command injection when a parameter is used as an OS command (Line 3, 1106); a check policy to prevent LDAP injection when using a parameter as an LDAP query (Line 4, 1107), and a check policy to prevent XPath injection when using a parameter as an XPath query (Line 5, 1106).

The unification unit 503 generates a check rule 105 according to the parameter trace result and the check policy 510. That is, when the parameter trace result is FIG. 11, the check rule generated is as is shown in FIG. 12. Thus, by correlating the check policies shown in FIG. 10 with the trace results shown in FIG. 11 and unifying them, it is possible to easily generate the check rule shown in FIG. 12.

As has been explained above, it is possible to easily generate the check rule 103 without having detailed knowledge about the web application 104. The security filter 103 can perform appropriate check processing by using the check rule 105.

Thus, the present invention provides a communication information monitoring apparatus used in a system providing a service to a client. The system includes a pseudo-client transmitting a request containing a trace value and a monitoring unit for monitoring the trace value in various positions in the system. By monitoring the trace value in various positions of the system so as to identify the parameter use position, it is possible to easily create an appropriate check rule without having detailed knowledge of the security and the web application.

It should be noted that the present invention is not to be limited to the aforementioned embodiment but include various embodiments without departing the spirit of the invention disclosed in the claims.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

1. A communication information monitoring apparatus used in a system for providing a service to a client via a network, the apparatus comprising:
a pseudo-client for transmitting a request containing a trace value; and
a monitoring unit for monitoring a trace value in various positions of the system,
wherein the communication information monitoring apparatus has a function to identify a position where a parameter is used by monitoring the trace value in various positions of the system.

2. The communication information monitoring apparatus according to claim 1, wherein identification of the position where the parameter is used is performed by identifying a use position of the parameter of the web application.

3. The communication information monitoring apparatus according to claim 1, further comprising:
a unification unit for unifying a particular result of the parameter use position with a preset security policy,
wherein a check rule in communication information monitoring is generated.

4. The communication information monitoring apparatus according to claim 2, wherein the unification unit performing monitoring of the trace value includes:
an SQL monitoring unit for monitoring an SQL statement for accessing a database, and
a response monitoring unit for monitoring a response message to be returned to the web application.

5. The communication information monitoring apparatus according to claim 2, further comprising:
a unification unit for unifying a particular result of the parameter use position with a preset security policy,
wherein a check rule in the communication information monitoring is generated.

6. The communication information monitoring apparatus according to claim 4, further comprising:
a unification unit for unifying a particular result of the parameter use position with a preset security policy,
wherein a check rule in the communication information monitoring is generated.
